(19) United States
(12) Patent Application Publication
(10) Pub. No.: US 2004/0051682 A1
(43) Pub. Date: Mar. 18, 2004

(54) Remotely updateable service signage

(76) Inventor: Randy D. Sines, Spokane, WA (US)

Correspondence Address: REIDLAW, L.L.C., 1926 SOUTH VALLEYVIEW LANE, SPOKANE, WA, 99212-0157, US

(21) Appl. No.: 10/244,874

(22) Filed: Sep. 17, 2002

(51) Int. Cl. G09G 3/00

(52) U.S. Cl. 345/30

(57) ABSTRACT

Embodiments in accordance with the present invention provide for a remotely updateable service sign. Such a service sign encompasses a first portion for indicating an exit or other location indicator of off-road service facilities and/or attractions, another portion having one or more logos or logo panels for identifying specific service or attraction providers, and an indicator region associated with or included within the logos or logo panels. Advantageously, the indicator region is configured to provide an indication of whether or not the specific service identified by the associated logo or logo panel is currently available by being remotely updateable. Other embodiments of the present invention include methods of providing such updateable service signs and methods of updating such signs.

### TECHNICAL FIELD

The present invention relates generally to an updateable article and methods and more specifically to remotely, automatically updateable service signage and methods.

### BACKGROUND

Signage used on highways, freeways and other roads generally is in accordance with the guidance provided in the Manual on Uniform Traffic Control Devices (MUTCD) published by the Federal Highway Administration. That is to say that while each of the individual states, and therethrough, counties, cities and the like therein, can provide specific legislation or rules that control the use of such signage, such legislation or rules generally follow the MUTCD's guidance.

Referring to FIG. 1, an example of a specific service sign 10 as depicted in the MUTCD, published December 2001, is provided. Sign 10 has a first portion 20 indicating an exit number, a second portion 22 for displaying a first service, specifically GAS, available at the exit number provided in portion 20, and a third portion 24 for displaying a second service, specifically LODGING, available at the exit number provided in portion 20. Each of portions 22 and 24 have a plurality of regions, indicated by rectangles 30, 32 and 34 in portion 22 and rectangles 36, 38 and 40 in portion 24, for displaying a logo to identify specific service providers. As indicated by the MUTCD, in Chapter 2F “Specific Service Signs,” each logo can be either an identification symbol/trademark or a word message.

Such specific service signs as described in the MUTCD can successfully identify services and attractions that are available at specific locations proximate a highway, freeway or other road. However, whether or not a particular service provider is available to provide the indicated service at the time a person views a particular sign is not provided. Thus such a person can travel to the location indicated by a service sign only to find that the service provider cannot provide the desired service. For example, where a person exits a highway to seek fuel or lodging, a fuel service provider may be closed and/or a lodging service provider may not have any available lodging. Hence it would be advantageous for such service signage to additionally provide an indication as to whether or not the service identified is currently available at the location indicated.

### SUMMARY

Embodiments in accordance with the present invention provide for remotely updateable service signs and methods thereof. Such service signs encompass a portion for indicating an exit or other location indicator of off-road service facilities and/or attractions, another portion having one or more logos or logo panels for identifying specific service facilities or attraction providers, and an indicator region associated with or included within the logos or logo panels. Advantageously, the indicator region is configured to provide changeable indicia of whether or not the specific service and/or service facility or attraction identified by an associated logo or logo panel is currently available. In addition, the changeable indicia of such updateable service signs are updateable by remotely sent signals to and received by such service signs. Some embodiments of the present invention include one or more electronic devices for receiving such remotely sent signals and for providing appropriate signals to the changeable indicia to effect a change where appropriate. In some embodiments, power for the operation of the changeable indicia and/or the one or more electronic devices is provided by a self contained, rechargeable power source, while in other embodiments, power is provided by conventional means such as direct connection to a power supply or batteries. Other embodiments of the present invention include methods of providing such updateable service signs and methods of updating such signs.

### BRIEF DESCRIPTION OF THE DRAWINGS

Embodiments of the invention are described below with reference to the following accompanying drawings.

FIG. 1 is an example of a specific service sign as provided in Chapter 2F of the Manual on Uniform Traffic Control Devices;

FIG. 2 is a simplified view of a first side of a remotely updateable service sign in accordance with embodiments of the present invention;

FIG. 3 is an enlarged view of a portion of the first side of the service sign depicted in FIG. 2;

FIG. 4 is a simplified view of a second side of a remotely updateable service sign in accordance with an embodiment of the present invention;

FIG. 5 is a simplified view of a second side of a remotely updateable service sign in accordance with another embodiment of the present invention; and

FIG. 6 is a simplified flow chart depicting steps for remotely updating an updateable service sign in accordance with embodiments of the present invention.

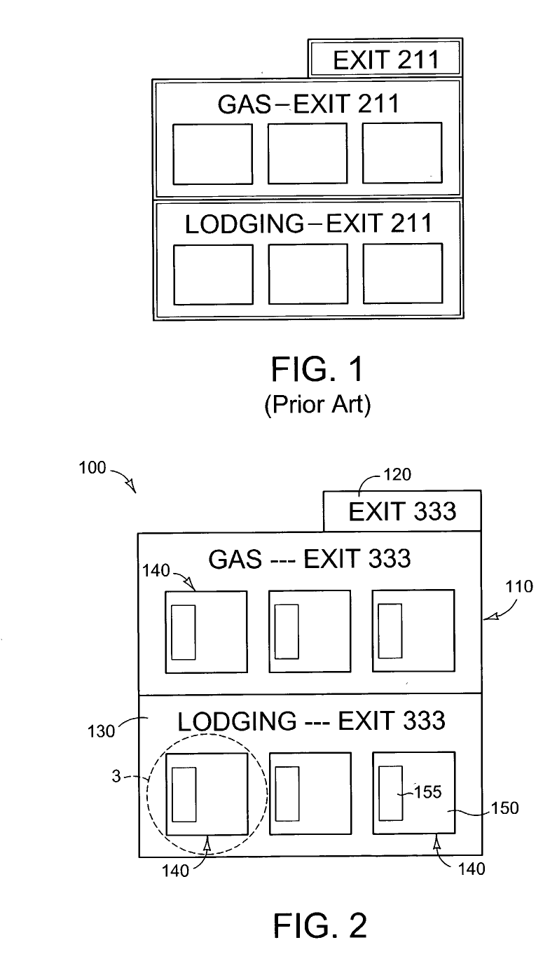

### DETAILED DESCRIPTION

Exemplary embodiments of the present invention will be described with reference to the aforementioned figures. Various modifications, adaptations or variations of such exemplary embodiments described herein may become apparent to those skilled in the art as such are disclosed. It will be understood that all such modifications, adaptations or variations that rely upon the teachings of the present invention, and through which these teachings have advanced the art, are considered to be within the scope and spirit of the present invention.

Referring to FIG. 2, a first side 110 of a remotely updateable service sign 100 in accordance with embodiments of the present invention is depicted. As per the guidance published in the Manual on Uniform Traffic Control Devices (MUTCD), first side 110 encompasses a first portion 120, which displays an exit number where the services indicated by the sign can be found. Alternatively, or where the road proximate sign 100 does not have exit numbers, first portion 120 can have words such as “Next Exit,” “Next Right,” “Second Right,” or the like to indicate where the services identified by the sign can be found. First side 100 also encompasses a second portion 130 within which, a plurality of logos or logo panels 140 are provided. Logos 140 provide identifications of businesses and/or attractions that are available proximate to the highway or road at the location indicated by first portion 120. Each of the plurality of logos or logo panels 140 includes a fixed region 150 and a changeable region 155, thus providing a plurality of fixed regions 150 and a plurality of changeable regions 155. However, it will be understood that in some embodiments in accordance with the present invention some of the plurality of logos or logo panels 140 can encompass only fixed regions 150.

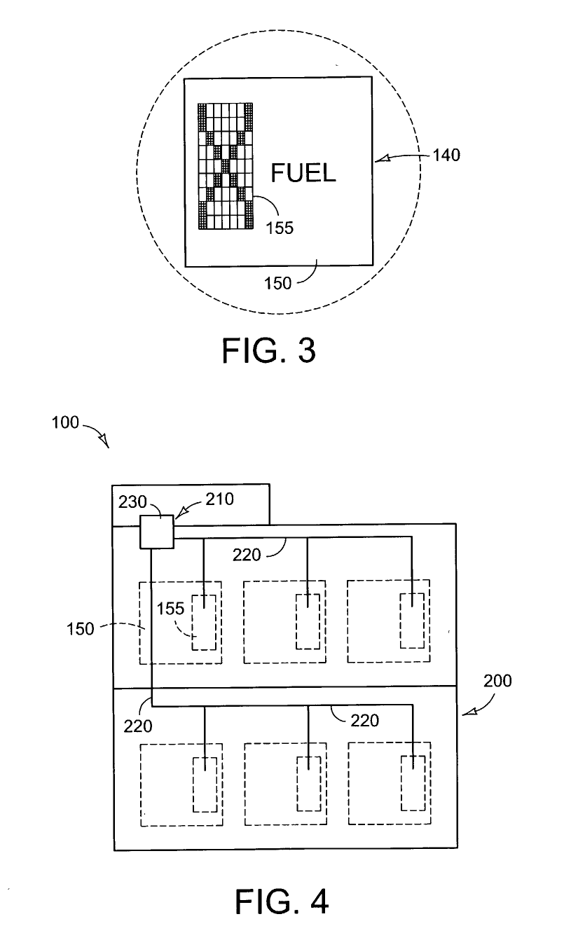

Turning to FIG. 3, an enlarged view of a logo or logo panel 140 having both fixed region 150 and changeable region 155 is provided. As depicted, fixed region 150 includes the word “Fuel” for exemplary purposes only and does not, in any way, limit embodiments of the present invention. Rather, it will be understood that fixed region 150 of logo 140 can include any identification symbol, trademark or word message that is in accordance with the guidance provided in Chapter 2F of the applicable MUTCD or in accordance with state or local legislation or rules enacted for the control or specification of specific service signage. Changeable region 155, also referred to herein as indicator region 155 and changeable indicator region 155, is depicted as including a 9 by 7 reflective matrix display device depicting an “X” mark. Such reflective matrix display having individual portions that can be changed mechanically from a forward facing reflective surface to a forward facing non-reflective surface.

As remarked above, the “X” mark and the use of a reflective matrix display device is for exemplary purposes only and does not, in any way, limit embodiments of the present invention. Thus indicator region 155 can encompass any device capable of providing changeable indicia of whether the service depicted in fixed region 150 is available. Such changeable indicia encompasses readily discernable indicator pairs such as the words open/closed or vacancy/no vacancy and/or symbolic indicator pairs such as check mark/X mark or red/green colored regions. In addition combinations of such indicator pairs or other appropriate indicator pairs can be employed. With regard to the method of displaying such indicator pairs, changeable indicator region 155 can encompass any of a variety of display devices or mechanisms. For example, liquid crystal displays (LCD), light emitting diode (LED) displays, “flip disc” displays, digital segment displays, any appropriate type of glow discharge or electrophoretic display, any appropriate fluorescent display or any appropriate mechanical display other than the 9 by 7 reflective matrix display device depicted in FIG. 3. One such exemplary other appropriate mechanical display, employs a mechanically operated panel that covers one or the other of the changeable indicia allowing only the desired indicia to be visible. It will be understood that the specific choice of device used for providing the changeable indicia of region 155 will be a function of several factors including, but not limited to, size, weight, cost, visibility, power requirements for operation and environmental conditions. Thus where, after consideration of some or all of the noted factors, a changeable region 155 encompassing a mechanical display is preferred in one geographic region, an LED display may be preferred in another.

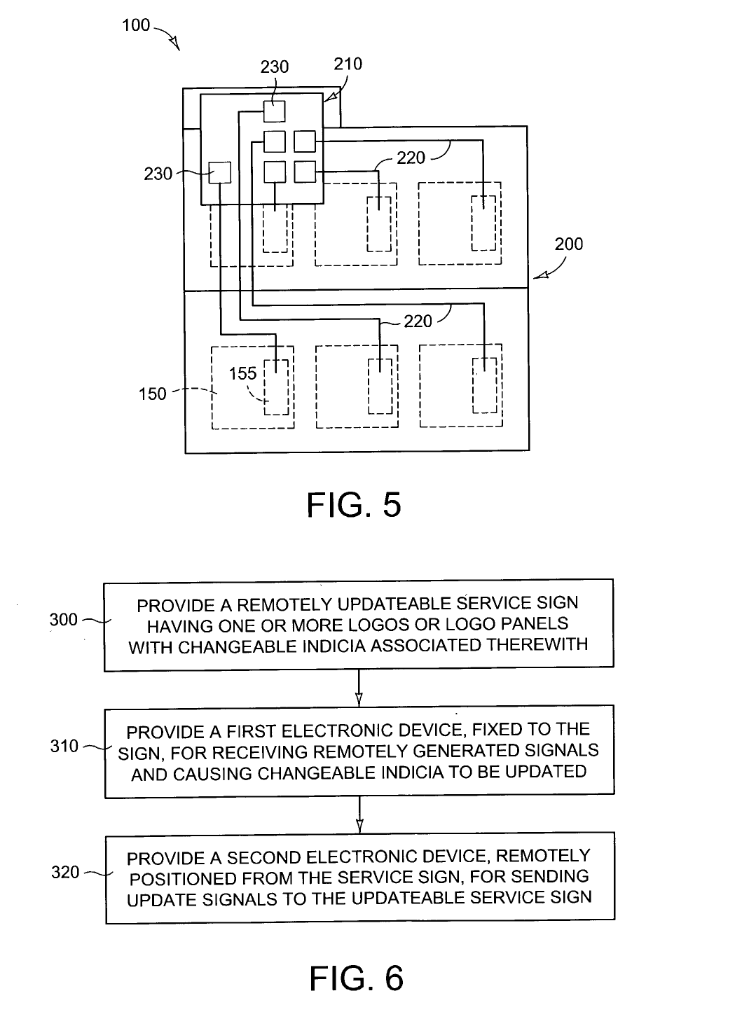

FIG. 4 is a simplified view of a second side 200 of a remotely updateable service sign 100 in accordance with an embodiment of the present invention. Second side 200 encompasses an electronic device 210 configured to receive signals for updating the plurality of indicator regions 155 (FIG. 2 and shown here with dashed lines) and to update each indicator region of such plurality of indicator regions 155. As depicted, electronic device 210 is fixably attached to second side 200 and encompasses a plurality of signal conduits 220 coupling each indicator region 155 with electronic device 210. In some embodiments of the present invention, electronic device 210 encompasses a single electronic module 230 for both receiving a signal sent by a remote device (not shown) and for providing a signal to each of the coupled changeable indicator regions 155, when appropriate. In some embodiments, there can be an electronic device 210 having a single electronic module 230 for each changeable indicator region 155, as shown in FIG. 5. In other embodiments in accordance with the present invention, electronic device 210 can encompass more than one electronic module, whether such is a single device for updating multiple indicator regions 155 as shown in FIG. 4, or multiple devices each coupled to a single indicator region 155 as depicted in FIG. 5. In addition, electronic device 210 can encompass two or more electronic modules for receiving a signal sent by a remote device (not shown) and for providing a signal to each of the coupled changeable indicator regions 155 when appropriate. For example, in some embodiments of the present invention, electronic device 210 encompasses two electronic modules (not shown), a first module for receiving the remotely sent signal and a second module for distributing signals to appropriate indicator regions 155. In still other embodiments in accordance with the present invention, changeable indicator regions 155 include a monolithic module (not shown) encompassing changeable indicia and the electronic device for receiving remotely sent signals and for appropriately changing the indicia.

In contrast to the passive or non-updateable service signs currently known and employed, updateable service signage in accordance with the present invention requires a source of electrical energy. Where an embodiment of the present invention is deployed in a region where a fixed source of electrical energy is readily available, direct coupling to that source (not shown) can be advantageous. Where such a fixed energy source is not readily available or where direct coupling to such an available source is not desirable, a rechargeable energy source (not shown) coupled to updateable service signage of the present invention can be employed. For example, each updateable service sign can encompass a solar panel and storage battery coupled to the changeable indicia and/or any electronic device of such updateable signage. Alternately, where multiple changeable service signs in accordance with the present invention are deployed proximate one another, a single rechargeable energy source can be provided and such source fixably coupled to each of the proximate service signs. In addition to a solar panel coupled to a storage battery, alternate sources of power for the updateable service signage of the present invention is contemplated. For example, such alternate sources include, but are not limited to, fuel cells, a thermally generated electrical energy source, electrical energy generated by wind power and the like.

It will be understood that the various choices for implementing the changeable indicia of embodiments of the present invention as well as the number of such changeable indicia employed will be a factor in the amount of power required for operation. Thus in addition to direct connection to a power source or a rechargeable power source, some embodiments of the present invention include a replaceable energy storage device, for example a battery.

In FIG. 6, a flow chart depicting steps for remotely updating an updateable service sign, in accordance with embodiments of the present invention, is provided. Step 300 encompasses providing a service sign, such as updateable service sign 100 (FIG. 2), having at least one logo or logo panel that includes an indicator region associated therewith or included within. As described above, such indicator region encompasses changeable indicia configured to provide an indication of whether or not the specific service identified by the associated logo or logo panel is currently available. Step 310 encompasses providing such signage with an electronic device coupled to the indicator region where the electronic device is configured to receive a signal for changing the changeable indicia of the indicator region and further configured to cause the updating of such indicator region by changing the changeable indicia if appropriate. Step 320 encompasses providing a second electronic device (not shown) positioned apart from the service sign and configured to send the remotely generated signal for updating to the updateable service sign. For embodiments in accordance with the present invention, such a second electronic device encompasses both a first module (not shown) for generating and sending an appropriate signal and a second module (not shown) for causing the signal to be generated.

The type of signal generated and sent to the updateable service signage of the present invention by the first module is generally a form of broadcast signal such as a radio wave, although other appropriate signals can be employed and are contemplated. In some embodiments, the signal is sent directly to the updateable service signage by the specific service or attraction facility identified therein. Since the guidance provided in the MUTCD provides that such facilities be within a limited distance from such signage, a radio wave broadcast signal of an appropriate wavelength and power can be readily employed. Alternatively, and where appropriate, a microwave or other line-of-sight signal can be employed. In addition, the type of signal employed by a service or attraction provider can advantageously take advantage of other methodologies such as broad coverage cell phone networks and satellite networks even where the signal is generated by the specific service or attraction facility identified by proximate updateable signage and transmitted to such broad coverage network for relay to the signage. It should be realized that the use of such broad coverage networks for relaying an update signal provides for such signal to be generated from virtually any global location.

The nature or content of the update signal will be a function of, among other things, the type of signal employed and the nature of the electronic device coupled to the indicator region of the signage. Thus where there is a locally generated signal directed to a specific sign and where the electronic device of the sign is coupled to a single indicator region, such locally generated signal need only provide update information. Alternatively, where the electronic device of the sign has a single receiving module coupled to a plurality of update modules or to a single update module configured to update a plurality of indicator regions, such locally generated signal will provide both update information and indicator identification information. The identification information is formatted in a manner recognizable by the electronic device of the signage to provide for the proper indicator region being updated. Where a broad coverage network is used to transmit or relay a remotely generated update signal, such signal will encompass signage identification information in addition to update information and, if required, indicator identification information. In this manner, while many updateable service signs may receive and decode such a broad coverage signal, only the appropriate service sign will update the appropriate indicator region. While generating, receiving and decoding the appropriate signal are elements of some embodiments of the present invention, it will be realized that any appropriate method and/or device or combination of methods and devices can be employed for the contemplated functions of signal generation, reception and decoding. Hence the specific details of such devices and methods need not be described herein.

As mentioned above, in embodiments of the present invention, the remotely generated signal for updating changeable indicia of updateable signage is automatically generated. That is to say, no action of a person directed solely to updating the changeable indicia of an updateable service sign need be performed. Thus for embodiments in accordance with the present invention, the remotely generated signal is initiated by an action, performed by a person or a device, having another purpose. For example, where the specifically identified service is a hotel, motel or other lodging provider, the signal can be caused to be generated by a computing device running the lodging provider's reservation or booking system which is directed, generally, to reserving and booking lodging for guests. Thus in addition to such reservation or booking system performing previously known functions, such system can include instructions for appropriately updating the changeable indicia of service signage when such system determines that the availability of lodging has changed. Alternately, where a lodging provider has an onsite or remote “vacancy/no vacancy” indicator, the changing of such indicator from one status to the other can be used to cause a signal to be automatically sent to updateable service signage. It will be understood that the use of a computing device and/or an instruction set operating thereon for generating an update signal is not limited to lodging providers. Other service providers can also appropriately use such devices and/or instruction sets. Thus where a fuel provider employs a computing system for monitoring fuel supplies and/or generating billing, such system can include instructions for generating an appropriate update signal when such system is started, stopped or when the fuel supply is exhausted. The generation of an update signal is not limited to a computing device and/or a set of instructions operating thereon. For example, an update signal can be caused to be generated by other devices and/or actions generally directed to another function. Thus a fuel or food provider can employ a device coupled to the establishment's lights, an open/closed sign at the establishment or a timing device directed to operate such lights and local signage.

While the update signals described above are locally generated, it will be understood that such signals can also be generated from a location remote to the local service provider. Thus, where a local lodging provider has a reservation or booking system coupled to a national or regional center, such national or regional center can provide for initiation of an update signal. In addition, some embodiments in accordance with the present invention include the providing of a national or regional signage update provider that any local service or attraction provider can use for generating update signals. Thus a service provider identified on an updateable service sign of the present invention can subscribe or otherwise enroll with such a national or regional update provider for providing update signals that have information appropriate for updating signs that identify the service provider. Such a national or regional update service can appropriately initiate an update signal based on the normal business hours of the specific service provider and/or any other agreed upon indication that the service provider is open to provide service. For example, such a national or regional update provider can initiate a signal to update changeable indicia where a local power failure causes a service provider to close.

It should be realized that embodiments of the present invention provide a variety of benefits not possible with existing service signage. For example, such embodiments can save a traveler a significant amount of time when such traveler is looking or an available service or attraction by positively identifying when such are actually available. That is to say, that travelers will no longer exit a road based on passive signage only to find a service or attraction closed. Such time savings will also lead to cost savings and reduced pollution and traffic congestion as the number of futile trips to locate a service or attractions will be reduced or in fact eliminated. In addition, signage of the present invention offers a benefit to an establishment that employs them as each specific service or attraction provider's logo or logo panel will be more readily visible to a traveler and such can make the use of such a provider's service or attraction more likely.

Embodiments in accordance with the present invention have been described hereinabove in language more or less specific as to structural and methodical features. It is to be understood, however, that the invention is not limited to the features shown and described above, since the means herein disclosed comprise only exemplary forms of putting the invention into effect. The invention is, therefore, claimed in any of its forms or modifications within the proper scope of the appended claims appropriately interpreted in accordance with the doctrine of equivalents.

1. A service sign comprising:
a first portion indicating an exit or other location indicator of off-road service facilities and/or attractions;
a second portion comprising one or more logos or logo panels for identifying specific service or attraction providers; and
an indicator region associated with or included within at least one of the logos or logo panels; the indicator region configured to provide a remotely updateable indication of whether or not the specific service identified by the associated logo or logo panel is currently available.

2. The service sign of claim 1, where the indicator region comprises a changeable reflective region or a changeable illuminated region.

3. The service signage of claim 3, where the indicator region is changeable between indicator pairs that appropriately indicate whether the service identified by the associated logo or logo panel is available or not available.

4. The service sign of claim 3, where the indicator region is changeable between indicator pairs selected from the group consisting of “open” or “closed,” “vacancy” or “no vacancy,” a check mark or an X mark, red or green colored regions, and combinations thereof.

5. The service sign of claim 1, further comprising a plurality of logos or logo panels and a plurality of indicator regions, each of the plurality of indicator regions associated with one of the plurality of logos or logo panels.

6. The service sign of claim 1, further comprising an electronic device configured to receive a signal for updating the indicator region and to update such indicator region in response to receiving the signal.

7. The service sign of claim 6, where the electronic device comprises a first module for receiving the signal and a second module for updating the indicator region.

8. The service sign of claim 1, where the one or more logos or logo panels is a plurality of logos or logo panels and the one indicator region is a plurality of indicator regions, each of the plurality of indicator regions associated with one of the plurality of logos or logo panels; and further comprising:
an electronic device configured to receive signals for updating the plurality of indicator regions and to update each indicator region of such plurality of indicator regions in response to receiving the signal.

9. The service sign of claim 8, where the electronic device comprises a first module for receiving the signal and a second module for updating the indicator region.

10. The service sign of claim 8, where the electronic device is a plurality of electronic devices, each of the plurality of electronic devices configured to receive a signal for updating a one of the plurality of indicator regions and updating such indicator region in response to receiving the signal.

11. The service signage of claim 8 where the indicator region is changeable between indicator pairs that appropriately indicate whether the service identified by the associated logo or logo panel is available or not available.

12. The service sign of claim 11, where each of the plurality of indicator regions is independently changeable between indicator pairs selected from the group consisting of “open” or “closed,” “vacancy” or “no vacancy,” a check mark or an X mark, red or green colored regions, and combinations thereof.

13. A method for providing an updateable service sign, comprising:
providing a service sign comprising an indicator region associated with or included within, at least one logo or logo panel of the service sign; the indicator region configured to provide a remotely updateable indication of whether or not the specific service identified by the associated logo or logo panel is currently available;
providing a first electronic device coupled to the indicator region, the electronic device configured to receive a remotely generated signal for updating the indicator region and to update such indicator region in response to receiving the signal; and
providing a second electronic device positioned apart from the service sign and configured to send the remotely generated signal for updating.

14. The method of claim 13, where the first electronic device comprises a first module for receiving the signal and a second module for updating the indicator region.

15. The method of claim 13, where the second electronic device is coupled to an apparatus configured to automatically cause the second electronic device to send the remotely generated signal for updating.

16. The method of claim 15, where the apparatus comprises a computing device coupled to the second electronic device.

17. The method of claim 15, where the apparatus comprises a set of instructions configured to operate on a computing device, the set of instructions operable to cause the sending of the remotely generated signal.

18. A method for updating a remotely updateable service sign, comprising:
providing a service sign comprising an indicator region associated with or included within at least one logo or logo panel of the service sign, the indicator region configured to provide a remotely updateable indication of whether or not the specific service identified by the associated logo or logo panel is currently available;
providing an electronic device coupled to the indicator region, the electronic device configured to receive a signal for updating the indicator region and to update such indicator region;
sending the signal for updating the indicator region;
receiving the signal; and
updating the indicator region in response to receiving the signal.

19. The method of claim 18, where the electronic device comprises a first module for receiving the signal and a second module for updating the indicator region.

20. The method of claim 18, where sending the signal for updating the indicator region comprises providing an apparatus for causing the signal to be automatically sent.

21. The method of claim 19, where the apparatus for causing the signal to be automatically sent comprises a computing device.

22. The method of claim 19, where the apparatus for causing the signal to be automatically sent comprises a set of instructions configured to operate on a computing device, the set of instructions operable to cause the signal to be automatically sent.
